(19) United States
(12) Patent Application Publication
(10) Pub. No.: US 2018/0365638 A1
(43) Pub. Date: Dec. 20, 2018

(54) METHOD AND DEVICE FOR PROCESSING DATA IN LOGISTICS AND DISTRIBUTION, AND COURIER MOBILE TERMINAL-BASED LOGISTICS AND DISTRIBUTION METHOD AND DEVICE

(71) Applicant: CAINIAO SMART LOGISTICS HOLDING LIMITED, Grand Cayman (KY)

(72) Inventors: YIBIN CHEN, HANGZHOU (CN); JIANFENG SHEN, HANGZHOU (CN); XINYI LIN, HANGZHOU (CN)

(21) Appl. No.: 16/113,584

(22) Filed: Aug. 27, 2018

Related U.S. Application Data
(63) Continuation of application No. PCT/CN2017/073717, filed on Feb. 16, 2017.

(30) Foreign Application Priority Data
Feb. 29, 2016 (CN) 201610113514.7

(51) Int. Cl. G06Q 10/08

(52) U.S. Cl. CPC G06Q 10/0835; G06Q 10/0838

(57) ABSTRACT

The present application provides a method and device for processing data in logistics and distribution, and a courier mobile terminal-based logistics and distribution method and device. The method for processing data in logistics and distribution includes: receiving logistics waybills in a preset time period and analyzing same to obtain delivery information of the logistics waybills; aggregating the logistics waybills according to distance relationships between the delivery address information of the logistics waybills and preset aggregate addresses, to form logistics waybill aggregates; for each logistics waybill aggregate, screening a courier information database according to the delivery information of the logistics waybills included in the logistics waybill aggregate and the preset aggregate address corresponding to the logistics waybill aggregate, to obtain a courier meeting a preset screening condition; and sending information of the logistics waybill aggregates to the courier. The present application reduces the delivery costs in logistics and distribution, and provides a rural-oriented logistics and distribution solution. The present application further provides a method for evaluating a delivery service of a courier.

### CROSS-REFERENCE TO RELATED APPLICATIONS

This application is a continuation application of International Patent Application No. PCT/CN2017/073717, filed on Feb. 16, 2017, which claims priority to China Patent Application No. 201610113514.7, filed with the China Patent Office on Feb. 29, 2016 and entitled “METHOD AND DEVICE FOR PROCESSING DATA IN LOGISTICS AND DISTRIBUTION, AND COURIER MOBILE TERMINAL-BASED LOGISTICS AND DISTRIBUTION METHOD AND DEVICE.” The above referenced applications are incorporated herein by reference in their entirety.

### TECHNICAL FIELD

The present application relates to the field of logistics, and in particular, to a method, a device and electronic equipment for processing data in logistics and distribution. The present application also relates to a courier mobile terminal-based logistics and distribution method, device and electronic equipment. The present application further relates to a method and device for evaluating a delivery service of a courier.

### BACKGROUND

In the field of logistics, it has always been difficult to carry out logistics and distribution in relatively scattered and underdeveloped rural areas. Because geographical locations in rural areas are relatively scattered, the average actual transport mileage per waybill in rural-oriented logistics and distribution is much longer than the transport mileage in urban distribution. As a result, the rural-oriented logistics and distribution require higher delivery costs. Moreover, in the rural-oriented logistics and distribution process, it is almost impossible to carry goods on both onward and return journeys. Usually, the vehicle is fully loaded in on the onward voyage and empty on the return voyage. This also causes a waste of transport capacity resources and additional delivery costs. Moreover, in rural-oriented door-to-door delivery, rural recipients are often not at home. As a result, one-time successful delivery rate is low, and multiple deliveries are needed. This also increases the delivery costs of rural-oriented logistics and distribution.

Due to the high delivery costs of the rural-oriented logistics and distribution, most existing logistics and distribution systems can only provide delivery services to a county level or town level. A logistics self pickup site is set up in a county or town, and related rural recipients go to the logistics self pickup site to pick up goods. Or, the door-to-door delivery service is only provided for goods charged with high logistics fees, such as furniture and household appliances.

The existing rural-oriented logistics and distribution systems mainly have the following disadvantages:

Due to the high delivery costs of the rural-oriented logistics and distribution, most logistics and distribution systems can only deliver goods to a county level or town level. Most goods cannot be delivered to a village level. As a result, rural recipients need to go to the county or town to pick up goods by themselves.

Only few goods can be delivered to the village level, with excessively high delivery costs. Repeated deliveries that occur frequently also increase the delivery costs.

### SUMMARY

The present application provides a method and device for processing data in logistics and distribution and a courier mobile terminal-based logistics and distribution method and device, so as to resolve the problems that an existing logistics and distribution system cannot conduct logistics and distribution to a village level, and the logistics and distribution to a village level require high costs and waste transport capacity resources. The present application further provides a method and device for evaluating a delivery service of a courier.

The present application provides a method for processing data in logistics and distribution, including:

receiving data of logistics waybills in a preset time period;

analyzing data of the logistics waybills, to obtain delivery information of the logistics waybills, the delivery information of the logistics waybills including delivery address information;

aggregating the logistics waybills according to distance relationships between the delivery address information of the logistics waybills and preset aggregate addresses corresponding to a preset address division level, to form logistics waybill aggregates, where each logistics waybill aggregate includes at least one logistics waybill and corresponds to one preset aggregate address;

screening, for each logistics waybill aggregate, a courier information database according to the delivery information of the logistics waybills included in the logistics waybill aggregate and the preset aggregate address corresponding to the logistics waybill aggregate, to obtain a courier meeting a preset screening condition; and

sending information of the logistics waybill aggregates to the couriers screened out for the logistics waybill aggregates.

Optionally, the preset address division level includes a township level, a town level or a village level.

Optionally, the preset aggregate address may be an address where a logistics service station is set up; and the logistics service station is a service organization for receiving, storing, and sending out delivery objects of the logistics waybills.

Optionally, the aggregating the logistics waybills according to distance relationships between the delivery address information of the logistics waybills and preset aggregate addresses corresponding to a preset address division level, to form logistics waybill aggregates includes:

aggregating the logistics waybills to the preset aggregate addresses nearest to delivery addresses of the logistics waybills according to distances between the delivery address information of the logistics waybills and the preset aggregate addresses corresponding to the preset address division level, to form the logistics waybill aggregates.

Optionally, the couriers may include: freight drivers registered in the courier information database; and the freight drivers include: third-party freight drivers and self-support freight drivers.

Optionally, the courier information database includes: a database including geographical location information of the couriers and attribute information of delivery equipment of the couriers.

Optionally, before the step of screening, for each logistics waybill aggregate, a courier information database according to the delivery information of the logistics waybills included in the logistics waybill aggregate and the preset aggregate address corresponding to the logistics waybill aggregate, to obtain a courier meeting a preset screening condition, the following step is performed:

receiving registration information of the third-party freight drivers, and registering delivery-related information in the registration information into the courier information database after approval.

Optionally, the registration information of the third-party freight drivers includes: personal attribute information and transportation qualification information of the third-party freight drivers, as well as attribute information and transportation qualification information of delivery equipment of the third-party freight drivers.

Optionally, the delivery-related information in the registration information includes: attribute information of delivery equipment of the third-party freight drivers.

Optionally, before the step of screening, for each logistics waybill aggregate, a courier information database according to the delivery information of the logistics waybills included in the logistics waybill aggregate and the preset aggregate address corresponding to the logistics waybill aggregate, to obtain a courier meeting a preset screening condition, the following step is performed:

receiving geographical location information of the couriers sent by the couriers in real time, and updating geographical location information of the couriers in the courier information database.

Optionally, the screening, for each logistics waybill aggregate, a courier information database according to the delivery information of the logistics waybills included in the logistics waybill aggregate and the preset aggregate address corresponding to the logistics waybill aggregate, to obtain a courier meeting a preset screening condition includes:

based on a preset distance screening condition, screening the courier information database according to geographical location information of the couriers and the preset aggregate address information corresponding to the logistics waybill aggregate, to obtain distance-selectable couriers.

Optionally, the preset distance screening condition may be that: a distance from a geographical location of the courier to the preset aggregate address is in a preset range.

Optionally, the delivery information of the logistics waybills further includes delivery object attribute information, and the screening, for each logistics waybill aggregate, a courier information database according to the delivery information of the logistics waybills included in the logistics waybill aggregate and the preset aggregate address corresponding to the logistics waybill aggregate, to obtain a courier meeting a preset screening condition includes:

based on a preset volume and weight screening condition, screening the distance-selectable couriers according to the delivery object attribute information of the logistics waybills included in the logistics waybill aggregate and attribute information of the delivery equipment, to obtain transport-capacity-selectable couriers.

Optionally, the screening, for each logistics waybill aggregate, a courier information database according to the delivery information of the logistics waybills included in the logistics waybill aggregate and the preset aggregate address corresponding to the logistics waybill aggregate, to obtain a courier meeting a preset screening condition includes:

obtaining courier delivery service evaluation based on a preset method for evaluating a delivery service of a courier, and ranking the transport-capacity-selectable couriers in descending order of scores of the courier delivery service evaluation; and

calculating whether the value of delivery objects of the logistics waybills in the logistics waybill aggregate exceeds an upper value limit; if yes, selecting a self-support freight driver ranking first in the transport-capacity-selectable courier as the courier; otherwise, selecting a freight driver ranking first in the transport-capacity-selectable couriers as the screened-out courier.

Optionally, the information of the logistics waybill aggregate includes: the delivery information of the logistics waybills included in the logistics waybill aggregate and information of the preset aggregate address corresponding to the logistics waybill aggregate.

Optionally, the method for processing data in logistics and distribution may further include receiving feedback information that the couriers accept delivering logistics waybills in the logistics waybill aggregates.

Optionally, after the step of receiving feedback information that the couriers accept delivering the logistics waybills in the logistics waybill aggregates, the following step is performed:

receiving feedback information that the couriers have finished delivering the logistics waybills in the logistics waybill aggregates. In one embodiment, the receiving feedback information that the couriers have finished delivering the logistics waybills in the logistics waybill aggregates includes: if the feedback information indicates that the couriers have finished delivering the delivery objects of the logistics waybills to the preset aggregate addresses, sending, to recipients of the logistics waybills, information instructing the recipients to go to the preset aggregate addresses to pick up the delivery objects of the logistics waybills.

Optionally, after the step of receiving feedback information that the couriers have finished delivering the logistics waybills in the logistics waybill aggregates, the following step is performed:

calculating and settling delivery fees for the logistics waybills that have been delivered by the couriers.

Optionally, the calculating and settling delivery fees for the logistics waybills that have been delivered by the couriers includes: sending information of the delivery fees to the couriers.

Optionally, the data processing method is used for logistics and distribution from a county level to a village level.

The present application provides a device for processing data in logistics and distribution, including:

a logistics waybill data obtaining unit, configured to receive data of logistics waybills in a preset time period;

a logistics waybill delivery information obtaining unit, configured to analyze data of the logistics waybills, to obtain delivery information of the logistics waybills, the delivery information of the logistics waybills including delivery address information;

a logistics waybill aggregate establishing unit, configured to aggregate the logistics waybills according to distance relationships between the delivery address information of the logistics waybills and preset aggregate addresses corresponding to a preset address division level, to form logistics waybill aggregates, where each logistics waybill aggregate includes at least one logistics waybill and corresponds to one preset aggregate address;

a courier screening unit, configured to screen, for each logistics waybill aggregate, a courier information database according to the delivery information of the logistics waybills included in the logistics waybill aggregate and the preset aggregate address corresponding to the logistics waybill aggregate, to obtain a courier meeting a preset screening condition; and

a logistics waybill aggregate sending unit, configured to send information of the logistics waybill aggregates to the couriers screened out for the logistics waybill aggregates.

The present application provides electronic equipment for processing data in logistics and distribution, including:

a display;

a processor; and

a memory, configured to store a program for performing the following operations when read and executed by the processor: receiving data of logistics waybills in a preset time period; analyzing data of the logistics waybills, to obtain delivery information of the logistics waybills, the delivery information of the logistics waybills including delivery address information; aggregating the logistics waybills according to distance relationships between the delivery address information of the logistics waybills and preset aggregate addresses corresponding to a preset address division level, to form logistics waybill aggregates, where each logistics waybill aggregate includes at least one logistics waybill and corresponds to one preset aggregate address; screening, for each logistics waybill aggregate, a courier information database according to the delivery information of the logistics waybills included in the logistics waybill aggregate and the preset aggregate address corresponding to the logistics waybill aggregate, to obtain a courier meeting a preset screening condition; sending information of the logistics waybill aggregates to the couriers screened out for the logistics waybill aggregates; and receiving feedback information that the couriers accept delivering logistics waybills in the logistics waybill aggregates.

The present application further provides a method for evaluating a delivery service of a courier, including:

obtaining historical record information about logistics waybill delivery of the courier;

obtaining delivery behavior information data of the courier according to the historical record information;

performing classification calculation on the delivery behavior information data according to a preset dimension, to obtain single-class delivery behavior quantitative evaluation values, and setting a weight value of each class; and

performing weighted calculation by using the single-class delivery behavior quantitative evaluation values and the weight values of different classes, to obtain delivery service evaluation data of the courier.

Optionally, the delivery behavior information data of the courier includes delivery object attribute statistical data, delivery behavior evaluation data, and delivery timeliness data.

Optionally, the performing classification calculation on the delivery behavior information data according to a preset dimension, to obtain single-class delivery behavior quantitative evaluation values includes:

calculating a total waybill quantity of the courier according to the quantity of logistics waybills undertaken by the courier in the delivery behavior information data;

calculating an average deliverability rate per waybill of the courier according to the quantity of logistics waybills that have been successfully delivered by the courier in the delivery behavior information data and the total waybill quantity of the courier;

calculating an average completion time per waybill of the courier according to a time spent by the courier to complete logistics waybill delivery and the quantity of successfully delivered logistics waybills in the delivery behavior information data; and

calculating an average goods value per waybill of the courier according to the value of delivery objects of the logistics waybills that have been successfully delivered by the courier and the quantity of logistics waybills that have been successfully delivered by the courier in the delivery behavior information data.

Optionally, the performing weighted calculation by using the single-class delivery behavior quantitative evaluation values and the weight values of different classes, to obtain delivery service evaluation data of the courier includes:

based on a comprehensive scoring method, granting individual scores to the total waybill quantity, the average deliverability rate per waybill, the average completion time per waybill and the average goods value per waybill of the courier according to corresponding evaluation criteria, performing weighted summation on the individual scores based on the weight values of the different classes to obtain a total score, and using the total score as the courier delivery service evaluation.

Optionally, the corresponding evaluation criteria include:

the larger the total waybill quantity of the courier is, the higher the individual score of the total waybill quantity of the courier is;

the higher the average deliverability rate per waybill of the courier is, the higher the individual score of the average deliverability rate per waybill of the courier is;

the shorter the average completion time per waybill of the courier is, the higher the individual score of the average completion time per waybill of the courier is; and

the higher the average goods value per waybill of the courier is, the higher the individual score of the average goods value per waybill of the courier is.

Optionally, the weight values of the different classes include:

the weight values of the individual scores of the total waybill quantity and the average deliverability rate per waybill of the courier are four times the weight values of the individual scores of the average completion time per waybill and the average goods value per waybill of the courier.

Optionally, a method for calculating the quantity of logistics waybills that have been successfully delivered by the courier is: incrementing the quantity of logistics waybills that have been successfully delivered by the courier by one each time the logistics waybill delivered by the courier is actually signed for.

Optionally, a specific method for calculating an average completion time per waybill of the courier according to a time spent by the courier to complete logistics waybill delivery and the quantity of successfully delivered logistics waybills in the delivery behavior information data is: calculating a difference between a time point when the logistics waybill delivered by the courier is actually signed for and a time point when the courier undertakes the logistics waybill, to obtain a delivery completion time of the courier; and calculating a ratio of a total delivery completion time of the courier to the total quantity of the logistics waybills that have been successfully delivered by the courier, to obtain the average completion time per waybill.

The present application further provides a device for evaluating a delivery service of a courier, including:

a historical record information obtaining unit, configured to obtain historical record information about logistics waybill delivery of the courier;

a behavior information data obtaining unit, configured to obtain delivery behavior information data of the courier according to the historical record information;

a quantitative evaluation value calculation unit, configured to perform classification calculation on the delivery behavior information data according to a preset dimension, to obtain single-class delivery behavior quantitative evaluation values, and set a weight value of each class; and

a delivery evaluation calculation unit, configured to perform weighted calculation by using the single-class delivery behavior quantitative evaluation values and the weight values of different classes, to obtain delivery service evaluation data of the courier.

The present application further provides a courier mobile terminal-based logistics and distribution method, including:

receiving, by using a mobile terminal of the courier, information of a logistics waybill aggregate sent by a preset logistics data center;

sending, by using the mobile terminal of the courier, waybill accepting information corresponding to the information of the logistics waybill aggregate to the preset logistics data center; and

performing, according to delivery information of logistics waybills in the received information of the logistics waybill aggregate and preset aggregate address information corresponding to the logistics waybill aggregate, data processing for picking up and delivering delivery objects of the logistics waybills.

Optionally, the mobile terminal of the courier is installed in a preset mobile platform in a form of application software.

Optionally, before the step of receiving, by using a mobile terminal of the courier, information of a logistics waybill aggregate sent by a preset logistics data center, the following step is performed:

sending, by using the mobile terminal of the courier, registration information of a third-party freight driver to the preset logistics data center.

Optionally, before the step of receiving, by using a mobile terminal of the courier, information of a logistics waybill aggregate sent by a preset logistics data center, the following step is performed:

sending, by using the mobile terminal of the courier, geographical location information of the courier to the preset logistics data center in real time.

Optionally, the performing, according to delivery information of logistics waybills in the received information of the logistics waybill aggregate and preset aggregate address information corresponding to the logistics waybill aggregate, data processing for picking up and delivering delivery objects of the logistics waybills includes:

performing, according to delivery information of logistics waybills included in the logistics waybill aggregate in the received information of the logistics waybill aggregate and information of a preset aggregate address corresponding to the logistics waybill aggregate, data processing for picking up the delivery objects of the logistics waybills and delivering same to the preset aggregate address.

Optionally, the performing, according to delivery information of logistics waybills in the received information of the logistics waybill aggregate and preset aggregate address information corresponding to the logistics waybill aggregate, data processing for picking up and delivering delivery objects of the logistics waybills includes:

performing, according to delivery information of logistics waybills included in the logistics waybill aggregate in the received information of the logistics waybill aggregate, data processing for picking up the delivery objects of the logistics waybills and delivering same to delivery addresses of the logistics waybills.

Optionally, the performing, according to delivery information of logistics waybills included in the logistics waybill aggregate in the received information of the logistics waybill aggregate, data processing for picking up the delivery objects of the logistics waybills and delivering same to delivery addresses of the logistics waybills includes:

if a recipient of the logistics waybill cannot sign for the logistics waybill, performing data processing for delivering the delivery object of the logistics waybill to the preset aggregate address corresponding to the logistics waybill aggregate to which the logistics waybill belongs.

Optionally, after the step of performing, according to delivery information of logistics waybills in the received information of the logistics waybill aggregate and preset aggregate address information corresponding to the logistics waybill aggregate, data processing for picking up and delivering delivery objects of the logistics waybills, the following step is performed:

receiving, by using the mobile terminal of the courier, information of delivery fees for logistics waybills included in the logistics waybill aggregate.

Optionally, the method is used for logistics and distribution from a county level to a village level.

The present application further provides a courier mobile terminal-based logistics and distribution device, including:

a logistics waybill aggregate information receiving unit, configured to receive, by using a mobile terminal of the courier, information of a logistics waybill aggregate sent by a preset logistics data center;

a to-be-delivered logistics waybill aggregate sending unit, configured to send, by using the mobile terminal of the courier, waybill accepting information corresponding to the information of the logistics waybill aggregate to the preset logistics data center; and

a logistics waybill delivery unit, configured to perform, according to delivery information of logistics waybills in the received information of the logistics waybill aggregate and preset aggregate address information corresponding to the logistics waybill aggregate, data processing for picking up and delivering delivery objects of the logistics waybills.

The present application further provides courier mobile terminal-based logistics and distribution electronic equipment, including:

a display;

a processor; and

a memory, configured to store a program for performing the following operations when read and executed by the processor: receiving, by using a mobile terminal of the courier, information of a logistics waybill aggregate sent by a preset logistics data center; sending, by using the mobile terminal of the courier, waybill accepting information corresponding to the information of the logistics waybill aggregate to the preset logistics data center; and performing, according to delivery information of logistics waybills in the received information of the logistics waybill aggregate and preset aggregate address information corresponding to the logistics waybill aggregate, data processing for picking up and delivering delivery objects of the logistics waybills.

The embodiments of the present application have at least the following advantages:

In the present application, logistics waybills close to each other are aggregated into one batch and are delivered to a courier with a relatively short distance to a preset aggregate address, effectively reducing the actual average transport mileage per logistics waybill and improving the delivery timeliness of the courier, thereby effectively reducing the delivery costs of logistics and distribution.

In the technical solution of the present application, idle transport capacity resources in the society are used together with self-support transport capacity resources to carry out public cooperative delivery to a low address division level. This greatly increases available transport capacity resources, better implements nearest logistics and distribution, and significantly reduces the waste of self-support transport capacity resources and the delivery costs of logistics and distribution to the low address division level, thereby obtaining a better solution of logistics and distribution to the low address division level.

### BRIEF DESCRIPTION OF THE DRAWINGS

FIG. 1 is a flowchart of an embodiment of a method for processing data in logistics and distribution according to the present application;

FIG. 2 is a schematic diagram of an embodiment of a device for processing data in logistics and distribution according to the present application;

FIG. 3 is a schematic diagram of an embodiment of electronic equipment for processing data in logistics and distribution according to the present application;

FIG. 4 is a flowchart of an embodiment of a method for evaluating a delivery service of a courier according to the present application;

FIG. 5 is a schematic diagram of an embodiment of a device for evaluating a delivery service of a courier according to the present application;

FIG. 6 is a flowchart of an embodiment of a courier mobile terminal-based logistics and distribution method according to the present application;

FIG. 7 is a schematic diagram of an embodiment of a courier mobile terminal-based logistics and distribution device according to the present application; and

FIG. 8 is a schematic diagram of an embodiment of courier mobile terminal-based logistics and distribution electronic equipment according to the present application.

### DETAILED DESCRIPTION

The following description provides many specific details, so that the present application can be understood thoroughly. However, the present application can be implemented in many manners different from the implementations described herein. A person skilled in the art can make similar generalization without departing from the meaning of the present application. Therefore, the present application is not limited by the specific implementations disclosed in the following.

The present application provides a method, a device, and electronic equipment for processing data in logistics and distribution, a courier mobile terminal-based logistics and distribution method, device, and electronic equipment, and a method and device for evaluating a delivery service of a courier, which are described in detail one by one in the following embodiments. For ease of understanding of the technical solution of the present application, the background of the present application and the technical solution of the present application are described briefly first.

For example, a logistics enterprise cannot provide logistics and distribution to a village level due to high delivery costs of rural-oriented logistics and distribution. Goods can only be delivered to a town level; then a town-level logistics self pickup site is set up, and related rural recipients are notified and go to the town logistics self pickup site to pick up goods.

The inventor of the present application hence provides a method, a device, and electronic equipment for processing data in logistics and distribution, a courier mobile terminal-based logistics and distribution method, device, and electronic equipment, and a method and device for evaluating a delivery service of a courier, so as to resolve the problem that logistics and distribution to a village level cannot be provided due to excessively high delivery costs of rural-oriented logistics and distribution.

The embodiments of the present application are described in order below with reference to the accompanying drawings.

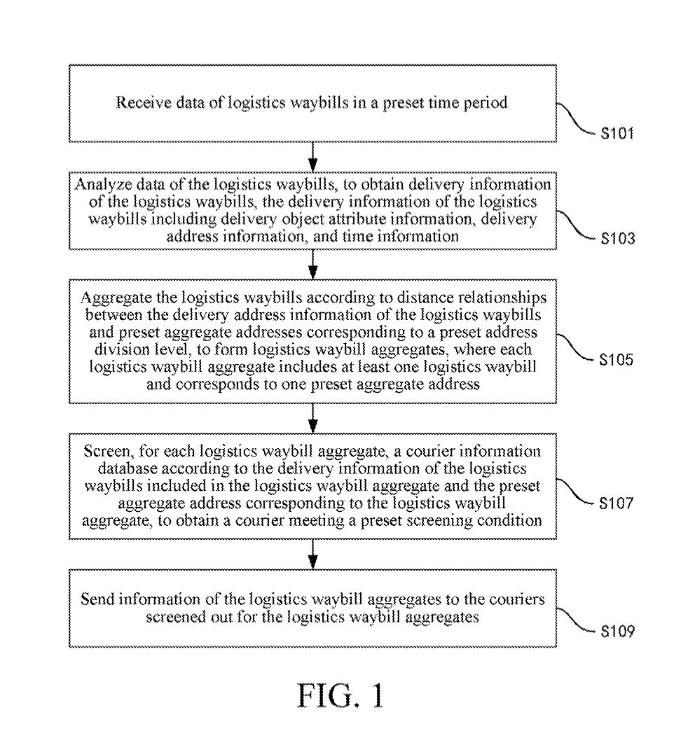

Referring to FIG. 1, FIG. 1 is a flowchart of an embodiment of a method for processing data in logistics and distribution according to the present application. In one embodiment, the present application provides a method for processing data in logistics and distribution, including the following steps:

Step S101: Receive data of logistics waybills in a preset time period.

Data of all logistics waybills in a preset time period is received from external logistics.

The preset time period is a period of time with specific duration that is set automatically or manually. The value of specific duration of the preset time period is determined according to the quantity of logistics waybills received from the external. If the quantity of received logistics waybills is large, a shorter duration can be set for the preset time period.

The logistics waybills all correspond to to-be-delivered goods. It can be considered that, receiving corresponding particular to-be-delivered goods means receiving a particular logistics waybill at the same time.

In this embodiment, a logistics enterprise receives, at a county-level logistics data center within a time period, for example, one hour, from a specific moment, data of logistics waybills corresponding to all to-be-delivered goods transported from the external logistics. For example, data of 400 logistics waybills correspond to to-be-delivered goods transported to the current county.

Step S103: Analyze data of the logistics waybills, to obtain delivery information of the logistics waybills, the delivery information of the logistics waybills including delivery object attribute information, delivery address information, and time information.

The received data of the logistics waybill is split and analyzed, to obtain delivery information of the logistics waybills. The delivery information of the logistics waybills includes attribute information, delivery address information, and time information of the logistics waybills. The attribute information is information such as description, specification, weight, model, and price of a delivery object. The time information is information such as a time point when a delivery object is sent out from a logistics start point and a time point before which the delivery object should be delivered to the destination.

In this embodiment, the received data of the 400 logistics waybills is split and analyzed, to obtain delivery information of the 400 logistics waybills, including attribute information of delivery objects such as descriptions, specifications, weights, prices of 500 delivery objects, 400 delivery addresses down to a village level and a group level, and time information such as time points when the delivery objects of the 400 logistics waybill are sent out and other timeline requirements.

Step S105: The logistics waybills are aggregated according to distance relationships between the delivery address information of the logistics waybills and preset aggregate addresses corresponding to a preset address division level, to form logistics waybill aggregates, where each logistics waybill aggregate includes at least one logistics waybill and corresponds to one preset aggregate address.

According to distance relationships between the delivery address information of the logistics waybills and preset aggregate addresses corresponding to a preset address division level, the logistics waybills are classified to form small classification sets of the logistics waybills, that is, logistics waybill aggregates. Each logistics waybill aggregate includes at least one logistics waybill and corresponds to one preset aggregate address.

The preset address division level includes a preset town level, township level or village level. Address division levels in China generally include a province division level, a prefecture (city) division level, a county division level, a town (township) division level, a village division level, a group (neighborhood) division level, and so on. For example, the address “Zhejiang Province, Jinhua City, Yunlai County, Qiyi Town, Hukou Village, Group 6” includes six address division levels of province, city, county, town, village, and group in descending order. The preset address division level in the present application is a village level, and it is set that the current county governs 10 townships, each township governs towns, and each town governs 20 villages. That is, it is set that the current county has 10 townships, 50 towns, and 1000 villages in total.

The preset aggregate address may be an address where a logistics service station is set up; and the logistics service station is a service organization for receiving, storing, and sending out delivery objects of the logistics waybills.

The preset aggregate addresses corresponding to the preset address division level in this embodiment are addresses where service organizations for receiving, storing, and sending out delivery objects of the logistics waybills are set up corresponding to the village level. For example, in this embodiment, it is set that preset aggregate addresses of logistics service stations are set in 100 villages of the current county. It should be noted that, setting up logistics service stations at the preset address division level is a premise for implementing the technical solution of the present application. The nearest delivery is made possible by matching logistics waybills and couriers based on logistics service stations set at a low address division level. It is also ensured that resource and cost wastes caused by repeated delivery are avoided.

The logistics waybills are aggregated to the preset aggregate addresses nearest to delivery addresses of the logistics waybills according to distances between the delivery address information of the logistics waybills and the preset aggregate addresses corresponding to the preset address division level, to form the logistics waybill aggregates.

In this embodiment, according to delivery addresses specific down to the village level and group level of the 400 logistics waybills and the 100 preset aggregate addresses where logistics service stations are set up, the 400 logistics waybills are separately classified to the nearest preset aggregate addresses, to form 80 logistics waybill aggregates corresponding to 80 preset aggregate addresses. Each logistics waybill aggregate includes 1 to 20 logistics waybills, and each logistics waybill aggregate corresponds to 1 preset aggregate address.

Step S107: Screen, for each logistics waybill aggregate, a courier information database according to the delivery information of the logistics waybills included in the logistics waybill aggregate and the preset aggregate address corresponding to the logistics waybill aggregate, to obtain a courier meeting a preset screening condition.

For each logistics waybill aggregate, based on a preset screening condition, the courier is screened out from the courier information database according to the delivery object attribute information and the delivery address information in the delivery information of the logistics waybills included in the logistics waybill aggregate and the preset aggregate address corresponding to the logistics waybill aggregate, to obtain a courier meeting a preset screening condition. In this embodiment, for each of the 80 logistics waybill aggregates, a courier corresponding to each logistics waybill is screened out from the courier information database based on the preset screening condition.

The couriers may include freight drivers registered in the courier information database; and the freight drivers include: third-party freight drivers and self-support freight drivers.

The courier information database is an information database of third-party freight drivers and self-support freight drivers, and includes: a database including geographical location information of the couriers and attribute information of delivery equipment of the couriers. In this embodiment, the courier database is an information database of 500 third-party freight drivers and 100 self-support freight drivers. The information database at least includes geographical location information of the freight drivers and attribute information of delivery equipment of the freight drivers, such as load capacity and volume capacity.

The registration information of the third-party freight drivers includes: personal attribute information and transportation qualification information of the third-party freight drivers, as well as attribute information and transportation qualification information of delivery equipment of the third-party freight drivers. In this embodiment, the registration information the third-party freight drivers at least includes personal attribute information, geographical location information, and transportation qualification information of 500 third-party freight drivers as well as attribute information and transportation qualification information of delivery equipment of the 500 third-party freight drivers.

The delivery-related information in the registration information includes: attribute information of delivery equipment of the third-party freight drivers.

In one implementation of this embodiment, before the step of screening a courier information database to obtain a courier, the following step can be performed: receiving registration information of the third-party freight drivers, and registering delivery-related information in the registration information into the courier information database after approval. Before the step of screening the courier information database to obtain a courier, the registration information of the third-party freight drivers that is sent by drivers having idle public transport capacity resources and that is used for joining in logistics and distribution is received, and delivery-related qualification of the drivers and delivery equipment thereof is verified; after the delivery-related qualification passes the verification, the drivers are used as third-party freight drivers, and the delivery-related information thereof is registered to the courier information database. Drivers having idle public transport capacity resources are added to the logistics and distribution system as third-party freight drivers, to cooperate with the self-support freight drivers in rural-oriented logistics and distribution. This not only increases the number of selectable couriers, but also better implements nearest logistics and distribution, and reduces the waste of transport capacity resources as well as the delivery costs of rural-oriented logistics and distribution.

In a preferred solution of this embodiment, before the step of screening the courier information database to obtain a courier, the following step can further be performed: receiving geographical location information of the couriers sent by the couriers in real time, and updating geographical location information of the couriers in the courier information database. By updating real-time geographical location information of the couriers, couriers nearest to the preset aggregate addresses can be screened out more effectively.

The screening, for each logistics waybill aggregate, the courier information database to obtain the courier includes: based on a preset distance screening condition, screening the courier information database according to geographical location information of the couriers and the preset aggregate address information corresponding to the logistics waybill aggregate, to obtain distance-selectable couriers. The preset distance screening condition may be that: a distance from a geographical location of the courier to the preset aggregate address is in a preset range.

For example, in this embodiment, 500 third-party freight drivers and 100 self-support freight drivers are screened to obtain distance-selectable couriers, of which the geographical locations are within 10 km from the preset aggregate address, for 80 logistics waybill aggregates respectively. Finally, a total of 200 third-party freight drivers and 40 self-support freight drivers corresponding to the 80 logistics waybill aggregates are obtained by screening.

The screening, for each logistics waybill aggregate, the courier information database to obtain the courier includes: based on a preset volume and weight screening condition, screening the distance-selectable couriers according to the delivery object attribute information of the logistics waybills included in the logistics waybill aggregate and attribute information of the delivery equipment, to obtain transport-capacity-selectable couriers.

In this embodiment, 240 selectable couriers (200 third-party freight drivers and 40 self-support freight drivers) are screened according to the size and weight of the delivery objects, to obtain transport-capacity-selectable couriers whose delivery equipment can hold the delivery objects for the 80 logistics waybill aggregates respectively. Finally, a total of 120 third-party freight drivers and 30 self-support freight drivers are screened out.

The screening, for each logistics waybill aggregate, the courier information database to obtain the courier includes: obtaining courier delivery service evaluation based on a preset method for evaluating a delivery service of a courier, and ranking the transport-capacity-selectable couriers in descending order of scores of the courier delivery service evaluation; and calculating whether the value of delivery objects of the logistics waybills in the logistics waybill aggregate exceeds an upper value limit; if yes, selecting a self-support freight driver ranking first in the transport-capacity-selectable courier as the courier; otherwise, selecting a freight driver ranking first in the transport-capacity-selectable couriers as the screened-out courier.

In this embodiment, according to the scores of the courier delivery service evaluation obtained based on the preset method for evaluating a delivery service of a courier, the 150 freight drivers (120 third-party freight drivers and 30 self-support freight drivers) are ranked in descending order of the scores. After ranking, the freight driver with the highest score ranks first. The commodity value of the delivery objects of the logistics waybills included in each of the 80 logistics waybill aggregates is calculated. If the commodity value exceeds RMB 10,000 yuan, a self-support freight driver ranking first in the 30 self-support freight drivers of the transport-capacity-selectable couriers is screened out as the courier of the logistics waybill aggregate. If the commodity value does not exceed RMB 10,000 yuan, a freight driver ranking first in the 150 freight drivers of the transport-capacity-selectable couriers is screened out as the courier of the logistics waybill aggregate. For example, a self-support freight driver ranking third is screened out for No. 1 logistics waybill aggregate (including three logistics waybills and four delivery objects, and corresponding to No. 1 preset aggregate address); a third-party freight driver ranking first is screened out for No. 2 logistics waybill aggregate (including one logistics waybill and one delivery object, and corresponding to No. 2 preset aggregate address). The screening is performed until a freight driver is screened out for No. 80 logistics waybill aggregate. Finally, 65 third-party freight drivers and 15 self-support freight drivers that correspond to the 80 logistics waybill aggregates in a one-to-one manner are screened out.

This embodiment only discusses the situation where one different courier is screened out for each logistics waybill aggregate. The technical solution of the present application also includes a situation where one or more couriers are screened out for each logistics waybill aggregate, and a situation where an identical courier is screened out for multiple logistics waybill aggregates. By screening out multiple couriers for each logistics waybill aggregate, it is possible to implement fault tolerance when a screened-out courier reject to deliver the logistics waybill aggregate subsequently, and to continue to match the logistics waybill aggregate that is rejected by the screened-out courier with other selectable couriers meeting the screening condition.

S109: Send information of the logistics waybill aggregates to the couriers screened out for the logistics waybill aggregates.

Information required for delivery in the logistics waybill aggregates is sent to the couriers screened out for the logistics waybill aggregates.

The information required for delivery in the logistics waybill aggregate at least includes: the delivery information of the logistics waybills included in the logistics waybill aggregate and information of the preset aggregate address corresponding to the logistics waybill aggregate. In this embodiment, related attribute information of the 500 delivery objects as well as 400 pieces of delivery address information of the 400 logistics waybills in the 80 logistics waybill aggregates and 80 preset aggregate addresses corresponding to the 80 logistics waybill aggregates are sent to the 80 couriers screened out.

After the information of the logistics waybill aggregates are sent to the couriers, feedback information that the couriers accept delivering the logistics waybills in the logistics waybill aggregates can be received, to finally confirm that the sent-out logistics waybill aggregates have been matched with the couriers. Feedback information that the couriers accept delivering all delivery objects of the logistics waybills in the logistics waybill aggregates is received. The feedback information of accepting a waybill can be in many forms, for example, one character, and a group of digits.

After the feedback information that the couriers accept delivering the logistics waybills in the logistics waybill aggregates is received, feedback information that the couriers have finished delivering all the delivery objects of the logistics waybills in the logistics waybill aggregates can further be received.

The feedback information that the delivery has been completed can be in multiple forms, but should include information that the delivery objects have been delivered to the delivery addresses or the preset aggregate addresses.

If the feedback information indicates that the courier have finished delivering the delivery objects of the logistics waybills to the preset aggregate addresses, information instructing recipients of the logistics waybills to go to the preset aggregate addresses to pick up the delivery objects of the logistics waybills is sent to the recipients.

In this embodiment, for example, delivery objects of logistics waybills in 35 logistics waybill aggregates are delivered to the preset aggregate addresses and delivery objects of logistics waybills in 45 logistics waybill aggregates are delivered to the delivery addresses; in this case, information instructing recipients of the logistics waybills in the 35 logistics waybill aggregates delivered to the preset aggregate addresses to go to the preset aggregate addresses to pick up the delivery objects of the logistics waybills is sent to the recipients.

After the step of receiving feedback information that the couriers have finished delivering all the delivery objects of the logistics waybills in the logistics waybill aggregates, delivery fees for the logistics waybills that have been delivered by the couriers can be calculated and settled to related financial accounts. In this embodiment, delivery fees for the 400 logistics waybills are calculated and settled to financial accounts of the 80 freight drivers.

In a preferred solution of this embodiment, the calculating and settling delivery fees for the logistics waybills that have been delivered by the couriers may further include: sending information of the delivery fees to the couriers.

The data processing method in this embodiment achieves an optimal effect when applied to logistics and distribution from the county level to the village level. Certainly, the data processing method can also be applied to logistics and distribution among other address division levels.

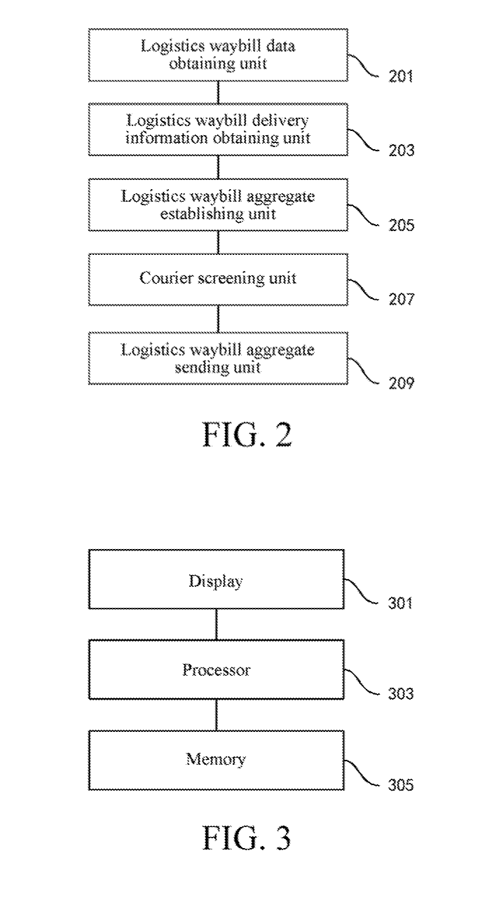

Referring to FIG. 2, FIG. 2 is a schematic diagram of a device for processing data in logistics and distribution according to the present application. The apparatus embodiment is basically similar to the method embodiment, and therefore is described in a relatively simple manner. For related parts, reference can be made to part of the description of the method embodiment. The apparatus embodiment described in the following is merely an example.

The present application provides a device for processing data in logistics and distribution, including:

a logistics waybill data obtaining unit 201, configured to receive data of logistics waybills in a preset time period;

a logistics waybill delivery information obtaining unit 203, configured to analyze data of the logistics waybills, to obtain delivery information of the logistics waybills, the delivery information of the logistics waybills including delivery object attribute information, delivery address information, and time information;

a logistics waybill aggregate establishing unit 205, configured to aggregate the logistics waybills according to distance relationships between the delivery address information of the logistics waybills and preset aggregate addresses corresponding to a preset address division level, to form logistics waybill aggregates, where each logistics waybill aggregate includes at least one logistics waybill and corresponds to one preset aggregate address;

a courier screening unit 207, configured to screen, for each logistics waybill aggregate, a courier information database according to the delivery information of the logistics waybills included in the logistics waybill aggregate and the preset aggregate address corresponding to the logistics waybill aggregate, to obtain a courier meeting a preset screening condition; and

a logistics waybill aggregate sending unit 209, configured to send information of the logistics waybill aggregates to the couriers screened out for the logistics waybill aggregates.

Referring to FIG. 3, FIG. 3 is a schematic diagram of electronic equipment for processing data in logistics and distribution according to the present application. The apparatus embodiment is basically similar to the method embodiment, and therefore is described in a relatively simple manner. For related parts, reference can be made to part of the description of the method embodiment. The apparatus embodiment described in the following is merely an example.

The present application provides electronic equipment for processing data in logistics and distribution, including: a display 301, a processor 303, and a memory 305.

The memory 305 is configured to store a program for performing the following operations when read and executed by the processor: receiving data of logistics waybills in a preset time period; analyzing data of the logistics waybills, to obtain delivery information of the logistics waybills, the delivery information of the logistics waybills including delivery object attribute information, delivery address information, and time information; aggregating the logistics waybills according to distance relationships between the delivery address information of the logistics waybills and preset aggregate addresses corresponding to a preset address division level, to form logistics waybill aggregates, where each logistics waybill aggregate includes at least one logistics waybill and corresponds to one preset aggregate address; screening, for each logistics waybill aggregate, a courier information database according to the delivery information of the logistics waybills included in the logistics waybill aggregate and the preset aggregate address corresponding to the logistics waybill aggregate, to obtain a courier meeting a preset screening condition; sending information of the logistics waybill aggregates to the couriers screened out for the logistics waybill aggregates; and receiving feedback information that the couriers accept delivering logistics waybills in the logistics waybill aggregates.

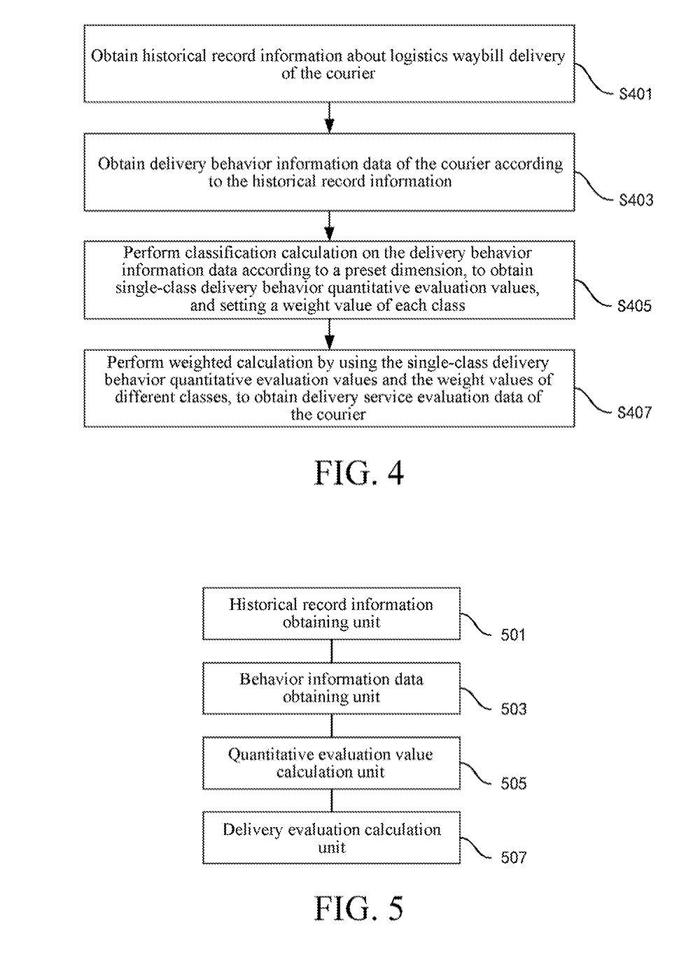

Referring to FIG. 4, FIG. 4 is a flowchart of an embodiment of a method for evaluating a delivery service of a courier according to the present application. In one embodiment, the method for evaluating a delivery service of a courier provided in the present application includes the following steps:

S401: Obtain historical record information about logistics waybill delivery of the courier.

The historical record information about logistics waybill delivery of the courier is obtained from a database of related logistics waybills and couriers.

For example, in this embodiment, historical record information related to logistics waybill delivery of a third-party freight driver is obtained from a database of related logistics waybills and couriers.

S403: Obtain delivery behavior information data of the courier according to the historical record information.

The delivery behavior information data of the courier includes delivery object attribute statistical data, delivery behavior evaluation data, and delivery timeliness data. For example, in this embodiment, some quantitative data such as logistics waybills undertaken and successfully delivered by the courier is obtained.

A total waybill quantity of the courier is calculated according to the quantity of logistics waybills undertaken by the courier in the delivery behavior information data.

The quantity of logistics waybills undertaken by the courier in the delivery behavior information data is accumulated, to obtain the total waybill quantity of the courier.

For example, in this embodiment, the total waybills quantity by the third-party freight driver is 1500.

S405: Perform classification calculation on the delivery behavior information data according to a preset dimension, to obtain single-class delivery behavior quantitative evaluation values, and set a weight value of each class.

First, quantitative calculation for classification is performed on the delivery behavior information data according to a preset dimension, and then a different weight value is set for each class.

An average deliverability rate per waybill of the courier is calculated according to the quantity of logistics waybills that have been successfully delivered by the courier in the delivery behavior information data and the total waybill quantity of the courier.

A percentage ratio of the quantity of logistics waybills that have been successfully delivered by the courier in the delivery behavior information data to the total waybill quantity of the courier is calculated, to obtain the average deliverability rate per waybill of the courier.

For example, in this embodiment, a percentage ratio of the quantity 1200 of successfully delivered logistics waybills of the third-party freight driver and the total waybill quantity 1500 of the third-party freight driver is 80%, and therefore the average deliverability rate per waybill of the third-party freight driver is 80%.

A method for calculating the quantity of logistics waybills that have been successfully delivered by the courier is: incrementing the quantity of logistics waybills that have been successfully delivered by the courier by one each time the logistics waybill delivered by the courier is actually signed for.

An average completion time per waybill of the courier is calculated according to a time spent by the courier to complete logistics waybill delivery and the quantity of successfully delivered logistics waybills in the delivery behavior information data.

A ratio of the total time spent by the courier to complete logistics waybill delivery to the total quantity of logistics waybills that have been successfully delivered by the courier in the delivery behavior information data is calculated, to obtain the average completion time per waybill of the courier.

A specific method for calculating an average completion time per waybill of the courier is: calculating a difference between a time point when the logistics waybill delivered by the courier is actually signed for and a time point when the courier undertakes the logistics waybill, to obtain a delivery completion time of the courier; and the specific method for calculating an average completion time per waybill of the courier is: calculating a ratio of a total delivery completion time of the courier to the total quantity of the logistics waybills that have been successfully delivered by the courier, to obtain the average completion time per waybill.

In this embodiment, a ratio of a total time, that is, 600 hours, spent by the third-party freight driver to finish delivering the logistics waybills in the delivery behavior information data to the total quantity 1200 of the logistics waybills that have been successfully delivered by the third-party freight driver is calculated, and it is obtained that the average completion time per waybill of the third-party freight driver is 0.5 hour/waybill.

An average goods value per waybill of the courier is calculated according to the value of delivery objects of the logistics waybills that have been successfully delivered by the courier and the quantity of logistics waybills that have been successfully delivered by the courier in the delivery behavior information data.

A ratio of the value of the delivery objects of the logistics waybills that have been successfully delivered by the courier to the quantity of logistics waybills that have been successfully delivered by the courier in the delivery behavior information data is calculated, to obtain the average goods value per waybill of the courier.

For example, in this embodiment, a ratio of the total value, that is, 240,000 yuan, of the delivery objects of the logistics waybills that have been successfully delivered by the third-party freight driver to the quantity 1200 of successfully delivered logistics waybills of the third-party freight driver is calculated, and it is obtained that the average goods value per waybill of the third-party freight driver is 200 yuan/waybill.

Secondly, setting weight values for different classes may include: setting the weight values of the individual scores of the total waybill quantity and the average deliverability rate per waybill of the courier to be four times the weight values of the individual scores of the average completion time per waybill and the average goods value per waybill of the courier.

For example, in this embodiment, the weight values of the individual scores of the total waybill quantity and the average deliverability rate per waybill are both set to 0.4, and the weight values of the individual scores of the average completion time per waybill and the average goods value per waybill are set to 0.1.

S407: Perform weighted calculation by using the single-class delivery behavior quantitative evaluation values and the weight values of different classes, to obtain delivery service evaluation data of the courier.

By using the specific quantitative values of the classes calculated in step S405, individual scores are granted according to different evaluation criteria of the classes, and weighted calculation is performed to obtain the delivery service evaluation data of the courier. The total score is used as the courier delivery service evaluation.

Based on a comprehensive scoring method, individual scores are granted to the total waybill quantity, the average deliverability rate per waybill, the average completion time per waybill and the average goods value per waybill of the courier according to corresponding evaluation criteria, weighted summation is performed on the individual scores based on the weight values of the different classes to obtain a total score, and the total score is used as the courier delivery service evaluation.

The evaluation criteria include: the larger the total waybill quantity of the courier is, the higher the individual score of the total waybill quantity of the courier is; the higher the average deliverability rate per waybill of the courier is, the higher the individual score of the average deliverability rate per waybill of the courier is; the shorter the average completion time per waybill of the courier is, the higher the individual score of the average completion time per waybill of the courier is; and the higher the average goods value per waybill of the courier is, the higher the individual score of the average goods value per waybill of the courier is.

For example, in this embodiment, according to the comprehensive scoring method, an individual score is granted to the total waybill quantity 1500 of the third-party freight driver by using the highest total waybill quantity 3000 of a courier in a logistics and distribution system as a criterion for a score of 100, and it is obtained that the individual score of the total waybill quantity is 50. By using an average deliverability rate per waybill of 100% of the courier as a criterion for a score of 100, an individual score is granted to the average deliverability rate per waybill of 80% of the third-party freight driver, and it is obtained that the individual score of the average deliverability rate per waybill is 80. By using the highest average completion time per waybill of 0.2 hour/waybill of the courier in the logistics and distribution system as a criterion for a score of 100, an individual score is granted to the average completion time per waybill of the third-party freight driver, and it is obtained that the individual score of the average completion time per waybill is 40. By using the highest average goods value per waybill of 235 yuan of the courier in the logistics and distribution system as a criterion for a score of 100, an individual score is granted to the average goods value per waybill of 200 yuan of the third-party freight driver, and it is obtained that the individual score of the average goods value per waybill is 85. The weight of the individual score of the total waybill quantity is 0.4, the weight of the individual score of the average deliverability rate per waybill is 0.4, the weight of the individual score of the average completion time per waybill is 0.1, and the weight of the individual score of the average goods value per waybill is 0.1. The individual scores are added in a weighted manner, to obtain a total score of 64.5, which is the delivery evaluation of the third-party freight driver.

Referring to FIG. 5, FIG. 5 is a schematic diagram of an embodiment of a device for evaluating a delivery service of a courier according to the present application. The apparatus embodiment is basically similar to the method embodiment, and therefore is described in a relatively simple manner. For related parts, reference can be made to part of the description of the method embodiment. The apparatus embodiment described in the following is merely an example.

A device for evaluating a delivery service of a courier provided in the present application includes:

a historical record information obtaining unit 501, configured to obtain historical record information about logistics waybill delivery of the courier;

a behavior information data obtaining unit 503, configured to obtain delivery behavior information data of the courier according to the historical record information;

a quantitative evaluation value calculation unit 505, configured to perform classification calculation on the delivery behavior information data according to a preset dimension, to obtain single-class delivery behavior quantitative evaluation values, and set a weight value of each class; and

a delivery evaluation calculation unit 507, configured to perform weighted calculation by using the single-class delivery behavior quantitative evaluation values and the weight values of different classes, to obtain delivery service evaluation data of the courier.

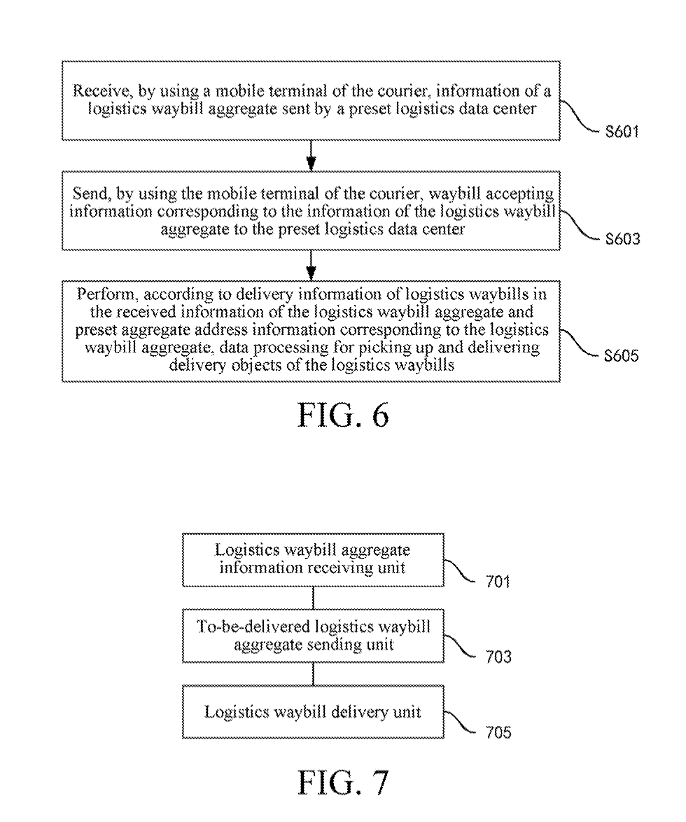

Referring to FIG. 6, FIG. 6 is a flowchart of an embodiment of a courier mobile terminal-based logistics and distribution method according to the present application. Corresponding to the method for processing data in logistics and distribution provided in the present application, the present application provides a courier mobile terminal-based logistics and distribution method, which includes the following steps:

S601: Receive, by using a mobile terminal of the courier, information of a logistics waybill aggregate sent by a preset logistics data center.

The information of the logistics waybill aggregate that is sent by the preset logistics data center and received by using the mobile terminal of the courier includes delivery information of logistics waybills in the logistics waybill aggregate and preset aggregate address information corresponding to the logistics waybill aggregate.

The mobile terminal of the courier installed in a preset mobile platform in a form of application software. For example, in this embodiment, the mobile terminal is a courier mobile application program installed on an Android phone.

In a preferred solution of this embodiment, before the step of receiving, by using a mobile terminal of the courier, information of a logistics waybill aggregate sent by a preset logistics data center is performed, a driver having an idle public transport capacity resource can send, by using the mobile terminal of the courier, information for registering as a third-party freight driver to the preset logistics data center, so as to apply to join in a logistics and distribution system of the preset logistics data center.

In a preferred solution of this embodiment, before the step of receiving, by using a mobile terminal of the courier, information of a logistics waybill aggregate sent by a preset logistics data center is performed, geographical location information of the courier can be sent to the preset logistics data center in real time by using the mobile terminal of the courier.

S603: Send, by using the mobile terminal of the courier, waybill accepting information corresponding to the information of the logistics waybill aggregate to the preset logistics data center.

Waybill accepting information of accepting delivery of the logistics waybills in the logistics waybill aggregate is sent to the preset logistics data center by using the mobile terminal of the courier.

The waybill accepting information can be in various forms, such as one byte and several digits, as long as the waybill accepting information can clearly reflect that delivery of the logistics waybills in the logistics waybill aggregate is accepted.

S605: Perform, according to delivery information of logistics waybills in the received information of the logistics waybill aggregate and preset aggregate address information corresponding to the logistics waybill aggregate, data processing for picking up and delivering delivery objects of the logistics waybills.

According to the delivery information of the logistics waybills in the received information of the logistics waybill aggregate and the preset aggregate address information corresponding to the logistics waybill aggregate, data processing for picking up the delivery objects of the logistics waybills and delivering same to the delivery addresses of the logistics waybills or the preset aggregate address is performed.

In one embodiment, according to delivery information of logistics waybills included in the logistics waybill aggregate in the received information of the logistics waybill aggregate and information of a preset aggregate address corresponding to the logistics waybill aggregate, data processing for picking up the delivery objects of the logistics waybills and delivering same to the preset aggregate address can be performed.

In one embodiment, alternatively, according to delivery information of logistics waybills included in the logistics waybill aggregate in the received information of the logistics waybill aggregate, data processing for picking up the delivery objects of the logistics waybills and delivering same to delivery addresses of the logistics waybills can be performed.

In one embodiment, if a recipient of the logistics waybill cannot sign for the logistics waybill, it is also possible to perform data processing for delivering the delivery object of the logistics waybill to the preset aggregate address corresponding to the logistics waybill aggregate to which the logistics waybill belongs.

It can be seen that, the technical solution of this embodiment overcomes the disadvantage of a low one-time delivery success rate, and ensures that the logistics waybill can be delivered successfully by performing delivery once or twice at most. As such, the timeliness of the logistics and distribution greatly improved, the transport mileage of logistics and distribution is reduced, and the capacity occupation of delivery equipment is reduced, thereby significantly reducing the delivery costs, and eliminating the obstacle in logistics and distribution to a low address division level.

In a preferred solution of this embodiment, after the step of performing, according to delivery information of logistics waybills in the received information of the logistics waybill aggregate and preset aggregate address information corresponding to the logistics waybill aggregate, data processing for picking up and delivering delivery objects of the logistics waybills, it is also possible to receive, by using the mobile terminal of the courier, information of delivery fees for logistics waybills included in the logistics waybill aggregate.

Similar to the method for processing data in logistics and distribution, the courier mobile terminal-based logistics and distribution method achieves an optimal effect when applied to logistics and distribution from a county level to a village level. Certainly, the courier mobile terminal-based logistics and distribution method can also be applied to logistics and distribution between other address division levels.

Referring to FIG. 7, FIG. 7 is a schematic diagram of an embodiment of a courier mobile terminal-based logistics and distribution device according to the present application. The apparatus embodiment is basically similar to the method embodiment, and therefore is described in a relatively simple manner. For related parts, reference can be made to part of the description of the method embodiment. The apparatus embodiment described in the following is merely an example.

A courier mobile terminal-based logistics and distribution device provided in the present application includes:

a logistics waybill aggregate information receiving unit 701, configured to receive, by using a mobile terminal of the courier, information of a logistics waybill aggregate sent by a preset logistics data center;

a to-be-delivered logistics waybill aggregate sending unit 703, configured to send, by using the mobile terminal of the courier, waybill accepting information corresponding to the information of the logistics waybill aggregate to the preset logistics data center; and

a logistics waybill delivery unit 705, configured to perform, according to delivery information of logistics waybills in the received information of the logistics waybill aggregate and preset aggregate address information corresponding to the logistics waybill aggregate, data processing for picking up and delivering delivery objects of the logistics waybills.

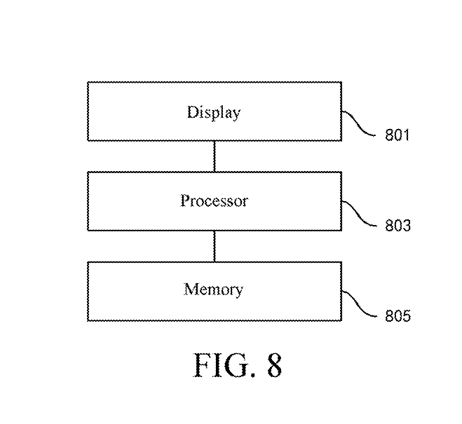

Referring to FIG. 8, FIG. 8 is a schematic diagram of an embodiment of courier mobile terminal-based logistics and distribution electronic equipment according to the present application. The apparatus embodiment is basically similar to the method embodiment, and therefore is described in a relatively simple manner. For related parts, reference can be made to part of the description of the method embodiment. The apparatus embodiment described in the following is merely an example.

Courier mobile terminal-based logistics and distribution electronic equipment provided by the present application includes: a display 801, a processor 803 and a memory 805.

The memory 805 is configured to store a program for performing the following operations when read and executed by the processor: receiving, by using a mobile terminal of the courier, information of a logistics waybill aggregate sent by a preset logistics data center; sending, by using the mobile terminal of the courier, waybill accepting information corresponding to the information of the logistics waybill aggregate to the preset logistics data center; and performing, according to delivery information of logistics waybills in the received information of the logistics waybill aggregate and preset aggregate address information corresponding to the logistics waybill aggregate, data processing for picking up and delivering delivery objects of the logistics waybills.

Although the present application is disclosed above by using preferred embodiments, the preferred embodiments are not intended to limit the present application. Any person skilled in the art can make possible changes and modifications without departing from the spirit and scope of the present application. Therefore, the protection scope of the present application should be subject to the scope defined by the claims of the present application.

In a typical configuration, a computing device includes one or more central processing units (CPUs), an input/output interface, a network interface, and a memory.

The memory may include a computer-readable medium in the form of, for example, a volatile memory, a random access memory (RAM) and/or a non-volatile memory such as a read-only memory (ROM) or a flash RAM. The memory is an example of a computer-readable medium.

1. The computer-readable medium includes non-volatile and volatile as well as movable and non-movable media, and can implement information storage by using any method or technology. The information can be computer readable instructions, a data structure, a module of a program or other data. Examples of the computer storage medium include, but are not limited to, a phase change memory (PRAM), a static random access memory (SRAM), a dynamic random access memory (DRAM), other types of RAMs, a ROM, an electrically erasable read-only memory (EEPROM), a flash memory or other memory technologies, a compact disc read-only memory (CD-ROM), a digital versatile disc (DVD) or other optical storage, a cassette tape, a magnetic tape/magnetic disk storage or other magnetic storage device, or any other non-transmission media, and can be used to store information accessible to the computing device. According to the definition herein, the computer readable medium does not include transitory media, such as modulated data signals and carriers.
2. A person skilled in the art should understand that, the embodiments of the present application can be provided as a method, a system or a computer program product. Therefore, the present application can be implemented in the form of a complete hardware embodiment, a complete software embodiment or an embodiment combining software and hardware. Moreover, the present application can be in the form of a computer program product implemented on a computer usable storage medium (including, but not limited to, a magnetic disk memory, a CD-ROM, and an optical memory) including computer usable program code.

What is claimed is:

1. A method for processing data in logistics and distribution, comprising:
receiving data of logistics waybills in a preset time period;
analyzing data of the logistics waybills, to obtain delivery information of the logistics waybills, the delivery information of the logistics waybills comprising delivery address information;
aggregating the logistics waybills according to distance relationships between the delivery address information of the logistics waybills and preset aggregate addresses corresponding to a preset address division level, to form logistics waybill aggregates, wherein each logistics waybill aggregate comprises at least one logistics waybill and corresponds to one preset aggregate address;
screening, for each logistics waybill aggregate, a courier information database according to the delivery information of the logistics waybills comprised in the logistics waybill aggregate and the preset aggregate address corresponding to the logistics waybill aggregate, to obtain a courier meeting a preset screening condition; and
sending information of the logistics waybill aggregates to the couriers screened out for the logistics waybill aggregates.

2. The method for processing data in logistics and distribution according to claim 1, wherein the preset address division level comprises a township level, a town level, or a village level.

3. The method for processing data in logistics and distribution according to claim 1, wherein the preset aggregate address includes an address where a logistics service station is set up; and the logistics service station is a service organization for receiving, storing, and sending out delivery objects of the logistics waybills.

4. The method for processing data in logistics and distribution according to claim 1, wherein the aggregating the logistics waybills according to distance relationships between the delivery address information of the logistics waybills and preset aggregate addresses corresponding to a preset address division level, to form logistics waybill aggregates comprises:
aggregating the logistics waybills to the preset aggregate addresses nearest to delivery addresses of the logistics waybills according to distances between the delivery address information of the logistics waybills and the preset aggregate addresses corresponding to the preset address division level, to form the logistics waybill aggregates.

5. The method for processing data in logistics and distribution according to claim 1, wherein the couriers include freight drivers registered in the courier information database; and the freight drivers comprise: third-party freight drivers and self-support freight drivers.

6. The method for processing data in logistics and distribution according to claim 1, wherein the courier information database comprises: a database comprising geographical location information of the couriers and attribute information of delivery equipment of the couriers.

7. The method for processing data in logistics and distribution according to claim 5, before the step of screening, for each logistics waybill aggregate, a courier information database according to the delivery information of the logistics waybills comprised in the logistics waybill aggregate and the preset aggregate address corresponding to the logistics waybill aggregate, to obtain a courier meeting a preset screening condition, comprising the step of:
receiving registration information of the third-party freight drivers, and registering delivery-related information in the registration information into the courier information database.

8. The method for processing data in logistics and distribution according to claim 7, wherein the registration information of the third-party freight drivers comprises: personal attribute information and transportation qualification information of the third-party freight drivers, as well as attribute information and transportation qualification information of delivery equipment of the third-party freight drivers.

9. The method for processing data in logistics and distribution according to claim 7, wherein the delivery-related information in the registration information comprises: attribute information of delivery equipment of the third-party freight drivers.

10. The method for processing data in logistics and distribution according to claim 1, before the step of screening, for each logistics waybill aggregate, a courier information database according to the delivery information of the logistics waybills comprised in the logistics waybill aggregate and the preset aggregate address corresponding to the logistics waybill aggregate, to obtain a courier meeting a preset screening condition, further comprising the step of:
receiving geographical location information of the couriers sent by the couriers in real time, and updating geographical location information of the couriers in the courier information database.

11. The method for processing data in logistics and distribution according to claim 1, wherein the screening, for each logistics waybill aggregate, a courier information database according to the delivery information of the logistics waybills comprised in the logistics waybill aggregate and the preset aggregate address corresponding to the logistics waybill aggregate, to obtain a courier meeting a preset screening condition comprises:
based on a preset distance screening condition, screening the courier information database according to geographical location information of the couriers and the preset aggregate address information corresponding to the logistics waybill aggregate, to obtain distance-selectable couriers.

12. The method for processing data in logistics and distribution according to claim 11, wherein the preset distance screening condition includes that: a distance from a geographical location of the courier to the preset aggregate address is in a preset range.

13. The method for processing data in logistics and distribution according to claim 11, wherein the delivery information of the logistics waybills further comprises the delivery object attribute information, and the screening, for each logistics waybill aggregate, a courier information database according to the delivery information of the logistics waybills comprised in the logistics waybill aggregate and the preset aggregate address corresponding to the logistics waybill aggregate, to obtain a courier meeting a preset screening condition comprises:
based on a preset volume and weight screening condition, screening the distance-selectable couriers according to the delivery object attribute information of the logistics waybills comprised in the logistics waybill aggregate and attribute information of the delivery equipment, to obtain transport-capacity-selectable couriers.

14. The method for processing data in logistics and distribution according to claim 13, wherein the screening, for each logistics waybill aggregate, a courier information database according to the delivery information of the logistics waybills comprised in the logistics waybill aggregate and the preset aggregate address corresponding to the logistics waybill aggregate, to obtain a courier meeting a preset screening condition comprises:
obtaining courier delivery service evaluation based on a preset method for evaluating a delivery service of a courier, and ranking the transport-capacity-selectable couriers in descending order of scores of the courier delivery service evaluation; and
calculating whether the value of delivery objects of the logistics waybills in the logistics waybill aggregate exceeds an upper value limit; if yes, selecting a self-support freight driver ranking first in the transport-capacity-selectable courier as the courier; otherwise, selecting a freight driver ranking first in the transport-capacity-selectable couriers as the screened-out courier.

15. The method for processing data in logistics and distribution according to claim 1, wherein the information of the logistics waybill aggregate comprises: the delivery information of the logistics waybills comprised in the logistics waybill aggregate and information of the preset aggregate address corresponding to the logistics waybill aggregate.

16. The method for processing data in logistics and distribution according to claim 1, wherein the receiving feedback information that the couriers have finished delivering the logistics waybills in the logistics waybill aggregates comprises: if the feedback information indicates that the couriers have finished delivering the delivery objects of the logistics waybills to the preset aggregate addresses, sending, to recipients of the logistics waybills, information instructing the recipients to go to the preset aggregate addresses to pick up the delivery objects of the logistics waybills.

17. The method for processing data in logistics and distribution according to claim 1, after the step of receiving feedback information that the couriers accept delivering the logistics waybills in the logistics waybill aggregates, comprising the step of:
receiving feedback information that the couriers have finished delivering the logistics waybills in the logistics waybill aggregates.

18. A device for processing data in logistics and distribution, comprising:
a processor; and
a memory storing a program for performing the following operations when executed by the processor: receiving data of logistics waybills in a preset time period; analyzing data of the logistics waybills, to obtain delivery information of the logistics waybills, the delivery information of the logistics waybills comprising delivery address information; aggregating the logistics waybills according to distance relationships between the delivery address information of the logistics waybills and preset aggregate addresses corresponding to a preset address division level, to form logistics waybill aggregates, wherein each logistics waybill aggregate comprises at least one logistics waybill and corresponds to one preset aggregate address; screening, for each logistics waybill aggregate, a courier information database according to the delivery information of the logistics waybills comprised in the logistics waybill aggregate and the preset aggregate address corresponding to the logistics waybill aggregate, to obtain a courier meeting a preset screening condition; and sending information of the logistics waybill aggregates to the couriers screened out for the logistics waybill aggregates.

19. A method for evaluating a delivery service of a courier, comprising:
obtaining historical record information about logistics waybill delivery of the courier;
obtaining delivery behavior information data of the courier according to the historical record information;
performing classification calculation on the delivery behavior information data according to a preset dimension, to obtain single-class delivery behavior quantitative evaluation values, and setting a weight value of each class; and
performing weighted calculation by using the single-class delivery behavior quantitative evaluation values and the weight values of different classes, to obtain delivery service evaluation data of the courier.

20. The method for evaluating a delivery service of a courier according to claim 19, wherein the delivery behavior information data of the courier comprises delivery object attribute statistical data, delivery behavior evaluation data, and delivery timeliness data.
